(19) United States
(12) Patent Application Publication
(10) Pub. No.: US 2019/0278716 A1
(43) Pub. Date: Sep. 12, 2019

(54) MEMORY CONTROLLER AND OPERATING METHOD THEREOF

(71) Applicant: SK hynix Inc., Gyeonggi-do (KR)

(72) Inventors: Young Ick CHO, Seoul (KR); Byeong Gyu PARK, Gyeonggi-do (KR); Sung Kwan HONG, Seoul (KR)

(21) Appl. No.: 16/157,677

(22) Filed: Oct. 11, 2018

(30) Foreign Application Priority Data
Mar. 6, 2018 (KR) 10-2018-0026503

(51) Int. Cl. G06F 12/1009; G06F 3/06

(52) U.S. Cl. CPC G06F 12/1009; G06F 3/0608; G06F 3/0661; G06F 2212/657; G06F 3/0673; G06F 3/0656; G06F 2212/1044; G06F 3/0659

(57) ABSTRACT

In a memory controller for controlling an operation of a memory device, the memory controller includes a map table buffer, a compressed map buffer, and a processor. The map table buffer stores map data received from the memory device. The compressed map buffer stores compressed map data generated by compressing the map data. The processor controls operations of the map table buffer and the compressed map buffer.

### CROSS-REFERENCE TO RELATED APPLICATION

The present application claims priority under 35 U.S.C. § 119(a) to Korean patent application number 10-2018-0026503, filed on Mar. 6, 2018, the entire disclosure of which is incorporated herein by reference in its entirety.

### BACKGROUND

### 1. Field of Invention

The present disclosure generally relates to an electronic device, and more particularly, to a memory controller and an operating method thereof.

### 2. Description of Related Art

Memory devices may be formed in a two-dimensional structure in which strings are arranged horizontally to a semiconductor substrate, or be formed in a three-dimensional structure in which strings are arranged vertically to a semiconductor substrate. A three-dimensional semiconductor device is a memory device devised in order to overcome the limit of degree of integration in two-dimensional semiconductor devices, and may include a plurality of memory cells vertically stacked on a semiconductor substrate.

### SUMMARY

Embodiments provide a memory controller capable of improving the operation speed of a memory system.

Embodiments also provide an operating method of a memory controller capable of improving the operation speed of a memory system.

In accordance with an aspect of the present disclosure, there is provided a memory controller for controlling an operation of a memory device, the memory controller including: a map table buffer configured to store map data received from the memory device; a compressed map buffer configured to store compressed map data generated by compressing the map data; and a processor configured to control operations of the map table buffer and the compressed map buffer.

The memory controller may receive a write request, write data, and a write logical address from a host, receive the map table data from a reserved area of the memory device, control the memory device to perform a program operation on the write data at a physical address corresponding to the write logical address, based on the map data, and update the map data according to the program operation.

The processor may control the map table buffer and the compressed map buffer to compress the map data updated according to the program operation of the memory device and store the compressed map data as the compressed map data in the compressed map buffer.

The memory controller may control the memory device to program the updated map data in the reserved area.

The compressed map buffer may store a descriptor of data included in the compressed map data.

The memory controller may receive a read request and a read logical address from the host, and determine whether a descriptor corresponding to the read logical address has been stored in the compressed map buffer.

When the descriptor corresponding to the read logical address is stored in the compressed map buffer, the memory controller may generate the map data by decompressing the compressed map data, and load the generated map table data into the map table buffer. The memory controller may control the memory device to read data, based on the loaded map data.

When the descriptor corresponding to the read logical address is not stored in the compressed map buffer, the memory controller may receive map data corresponding to the read logical address and load the received map data into the map table buffer. The memory controller may control the memory device to read data, based on the loaded map data.

In accordance with another aspect of the present disclosure, there is provided a method for operating a memory controller for controlling an operation of a memory device, the method including: receiving a write request from a host; receiving map data corresponding to the write request from the memory device; updating the map data and controlling the memory device to program data corresponding to the write request; controlling the memory device to program the updated map data to the memory device; and compressing and storing the updated map data.

In the compressing and storing of the updated map data, the updated map data may be stored as compressed map data in a compressed map buffer.

In the compressing and storing of the updated map data, a descriptor of data included in the compressed map data may be stored in the compressed map buffer.

In accordance with still another aspect of the present disclosure, there is provided a method for operating a memory controller for controlling an operation of a memory device, the method including: receiving a read request from a host; determining whether an address corresponding to the read request has been stored in a compressed map buffer; and loading map data, based on the determination result.

In the loading of the map data, based on the determination result, when the address corresponding to the read request is stored in the compressed map buffer, compressed map data stored in the compressed map buffer may be decompressed and then loaded as the map data.

In the loading of the map data, based on the determination result, when the address corresponding to the read request is not stored in the compressed map buffer, the map data may be received from the memory device.

The method may further include, after the loading of the map data, based on the determination result, generating a read command, based on the loaded map data.

In accordance with another aspect of the present disclosure, there is provided a memory system including a memory device having a cell array storing plural pieces of map data, each representing physical and logical locations of user data stored in the cell array; a first buffer configured to buffer one among the plural pieces of map data loaded from the cell array; a second buffer configured to buffer a compressed piece of map data corresponding to the piece of map data buffered in the first buffer and information indicating the logical locations included in the compressed pieces; and a processor. The processor is configured to: control, in response to a write request, the memory device to store user data into the cell array by loading the piece of map data onto the first buffer; update the loaded piece of map data according to the storing of the user data; control the memory device to store the updated piece of map data; compress the updated piece of map data; and generate the information according to the storing of the user data.

The processor may be further configured to: detect, in response to a read request, a read logical address included in the compressed piece of map data by referring to the information; decompress the compressed piece of map data into the first buffer; and control the memory device to perform a read operation based on the decompressed piece of map data.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system including a memory controller in accordance with an embodiment of the present disclosure.

FIG. 2 is a diagram illustrating a memory device of FIG. 1.

FIG. 3 is a block diagram illustrating a memory controller in accordance with an embodiment of the present disclosure.

FIG. 4 is a diagram illustrating a map table stored in a memory cell array of the memory device.

FIG. 5A is a diagram illustrating in more detail a configuration of the map table. FIG. 5B is a diagram illustrating a relationship of map data, compressed map data, and a data descriptor.

FIG. 6 is a flowchart illustrating an operating method of the memory controller in accordance with an embodiment of the present disclosure.

FIGS. 7A to 7C are block diagrams illustrating the operating method shown in FIG. 6.

FIG. 8 is a flowchart illustrating an operating method of the memory controller in accordance with an embodiment of the present disclosure.

FIGS. 9A to 9C are block diagrams illustrating a read process using compressed map data.

FIGS. 10A to 10C are block diagrams illustrating a read process using map data received from the memory device.

FIG. 11 is a diagram illustrating another embodiment of the memory system including the memory controller shown in FIG. 3.

FIG. 12 is a diagram illustrating another embodiment of the memory system including the memory controller shown in FIG. 3.

FIG. 13 is a diagram illustrating another embodiment of the memory system including the memory controller shown in FIG.

FIG. 14 is a diagram illustrating another embodiment of the memory system including the memory controller shown in FIG. 3.

### DETAILED DESCRIPTION

In the following detailed description, only certain exemplary embodiments of the present disclosure have been shown and described, simply by way of illustration. As those skilled in the art would realize, the described embodiments may be modified in various ways, all without departing from the spirit or scope of the present disclosure. Accordingly, the drawings and description are to be regarded as illustrative in nature and not restrictive.

In the entire specification, when an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

Hereinafter, exemplary embodiments of the present disclosure will be described in detail with reference to the accompanying drawings. The same reference numerals are used to designate the same elements as those shown in other drawings. In the following descriptions, only portions necessary for understanding operations in accordance with the exemplary embodiments may be described, and descriptions of the other portions may be omitted so as to not obscure important concepts of the embodiments.

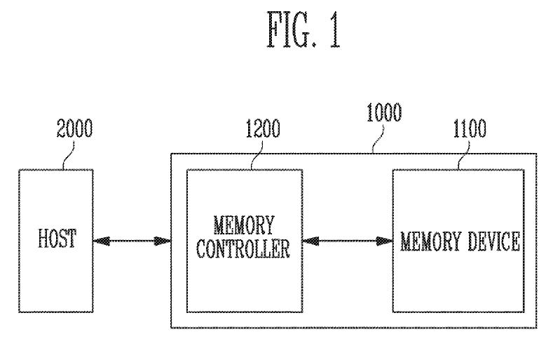

FIG. 1 is a diagram illustrating a memory system including a memory controller in accordance with an embodiment of the present disclosure.

Referring to FIG. 1, the memory system 1000 may include a memory device 1100 for storing data and a memory controller 1200 for controlling the memory device 1100 under the control of a host 2000.

The host 2000 may communicate with the memory system 1000 by using an interface protocol such as Peripheral Component Interconnect-Express (PCI-E), Advanced Technology Attachment (ATA), Serial ATA (SATA), Parallel ATA (PATA), or Serial Attached SCSI (SAS). Interface protocols between the host 2000 and the memory system 1000 are not limited to the above-described examples, and may be one of other interface protocols such as a Universal Serial Bus (USB), a Multi-Media Card (MMC), an Enhanced Small Disk Interface (ESDI), and Integrated Drive Electronics (IDE).

The memory controller 1200 may control the overall operations of the memory system 1000, and control data exchange between the host 2000 and the memory device 1100. For example, the memory controller 1200 may program or read data by controlling the memory device 1100 in response to a request from the host 2000. Also, the memory controller 1200 may store information of main memory blocks and sub-memory blocks, which are included in the memory device 1100, and select the memory device 1100 to perform a program operation on a main memory block or a sub-memory block according to the amount of data loaded for the program operation. In some embodiments, the memory device 1100 may include a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), and a flash memory.

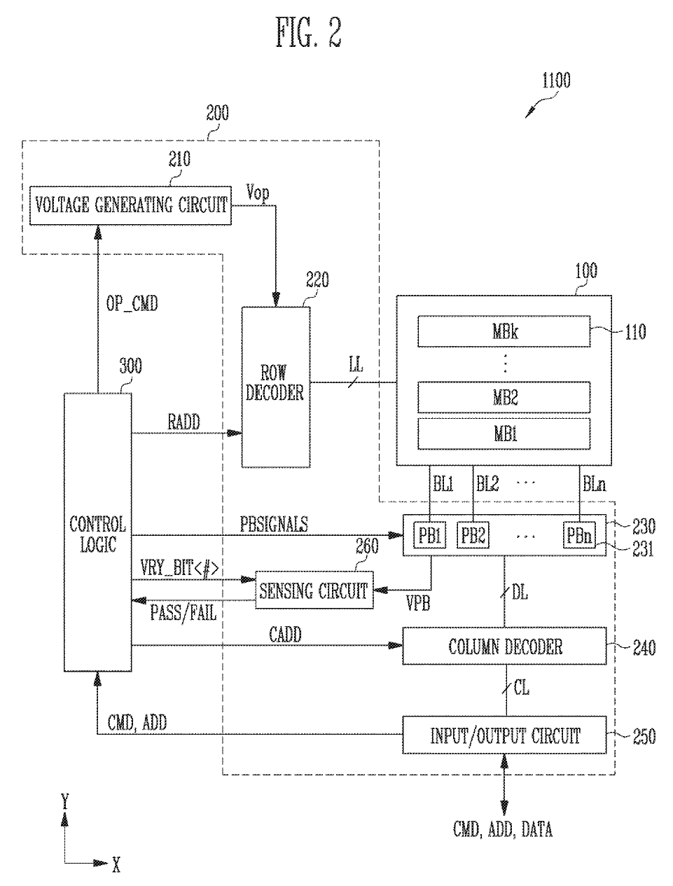

The memory device 1100 may perform a program, read or erase operation under the control of the memory controller 1200. A detailed configuration and operation of the memory device 1100 will be exemplarily described with reference to FIG. 2.

The memory controller 1200 in accordance with the embodiment of the present disclosure compresses and stores map data updated in a program operation. Meanwhile, in a read operation, the memory controller 1200 determines whether map data necessary for the read operation exists in the compressed map data, and loads the map data, based on the determination result. Accordingly, a procedure of reading map data from the memory device 1100 can be reduced, and thus the operation speed of the memory system can be improved. The memory controller 1200 in accordance with the embodiment of the present disclosure will be described in more detail with reference to FIG.

FIG. 2 is a diagram illustrating the memory device of FIG. 1.

Referring to FIG. 2, the memory device 1100 may include a memory cell array 100 that stores data. The memory device 1100 may include peripheral circuit 200 configured to perform a program operation for storing data in the memory cell array 100, a read operation for outputting the stored data, and an erase operation for erasing the stored data. The memory device 1100 may include a control logic 300 that controls the peripheral circuit 200 under the control of the memory controller (1200 of FIG. 1).

The memory cell array 100 may include a plurality of memory blocks MB1 to MBk (k is a positive integer) 110. Local lines LL and bit lines BL1 to BLn (n is a positive integer) may be coupled to the memory blocks MB1 to MBk 110. For example, the local lines LL may include a first select line, a second select line, and a plurality of word lines arranged between the first and second select lines. Also, the local lines LL may further include dummy lines arranged between the first select line and the word lines and between the second select line and the word lines. The first select line may be a source select line, and the second select line may be a drain select line. For example, the local lines LL may include word lines, drain and source select lines, and source lines SL. For example, the local lines LL may further include dummy lines. For example, the local lines LL may further include pipe lines. The local lines LL may be coupled to the memory blocks MB1 to MBk 110, respectively, and the bit lines BL1 to BLn may be commonly coupled to the memory blocks MB1 to MBk 110. The memory blocks MB1 to MBk 110 may be implemented in a two-dimensional or three-dimensional structure. For example, memory cells may be arranged in a direction parallel to a substrate in memory blocks 110 having a two-dimensional structure. For example, memory cells may be arranged in a direction vertical to a substrate in memory blocks 110 having a three-dimensional structure.

The peripheral circuit 200 may be configured to perform program, read, and erase operations of a selected memory block 110 under the control of the control logic 300. For example, the peripheral circuit 200, under the control of the control logic 300, may supply verify and pass voltages to the first select line, the second select line, and the word lines, selectively discharge the first select line, the second select line, and the word lines, and verify memory cells coupled a selected word line among the word lines. For example, the peripheral circuit 200 may include a voltage generating circuit 210, a row decoder 220, a page buffer group 230, a column decoder 240, an input/output circuit 250, and a sensing circuit 260.

The voltage generating circuit 210 may generate various operating voltages Vop used for program, read, and erase operations in response to an operation signal OP_CMD. Also, the voltage generating circuit 210 may selectively discharge the local lines LL in response to the operation signal OP_CMD. For example, the voltage generating circuit 210 may generate a program voltage, a verify voltage, pass voltages, a turn-on voltage, a read voltage, an erase voltage, a source line voltage, and the like under the control of the control logic 300.

The row decoder 220 may transfer the operating voltages Vop to local lines LL coupled to a selected memory block 110 in response to a row address RADD.

The page buffer group 230 may include a plurality of page buffers PB1 to PBn 231 coupled to the bit lines BL1 to BLn. The page buffers PB1 to PBn 231 may operate in response to page buffer control signals PBSIGNALS. For example, the page buffers PB1 to PBn 231 may temporarily store data received through the bit lines BL1 to BLn, or sense voltages or current of the bit lines BL1 to BLn in a read or verify operation.

The column decoder 240 may transfer data between the input/output circuit 250 and the page buffer group 230 in response to a column address CADD. For example, the column decoder 240 may exchange data with the page buffers 231 through data lines DL, or exchange data with the input/output circuit 250 through column lines CL.

The input/output circuit 250 may transfer a command CMD and an address ADD, which are received from the memory controller (1200 of FIG. 1), to the control logic 300, or communicate data DATA with the column decoder 240.

In a read operation or verify operation, the sensing circuit 260 may generate a reference current in response to a permission bit VRY_BIT<#>, and output a pass signal PASS or a fail signal FAIL by comparing a sensing voltage VPB received from the page buffer group 230 with a reference voltage generated by the reference current.

The control logic 300 may control the peripheral circuit 200 by outputting the operation signal OP_CMD, the row address RADD, the page buffer control signals PBSIGNALS, and the permission bit VRY_BIT<#> in response to the command CMD and the address ADD. Also, the control logic 300 may determine whether the verify operation has passed or failed in response to the pass or fail signal PASS or FAIL.

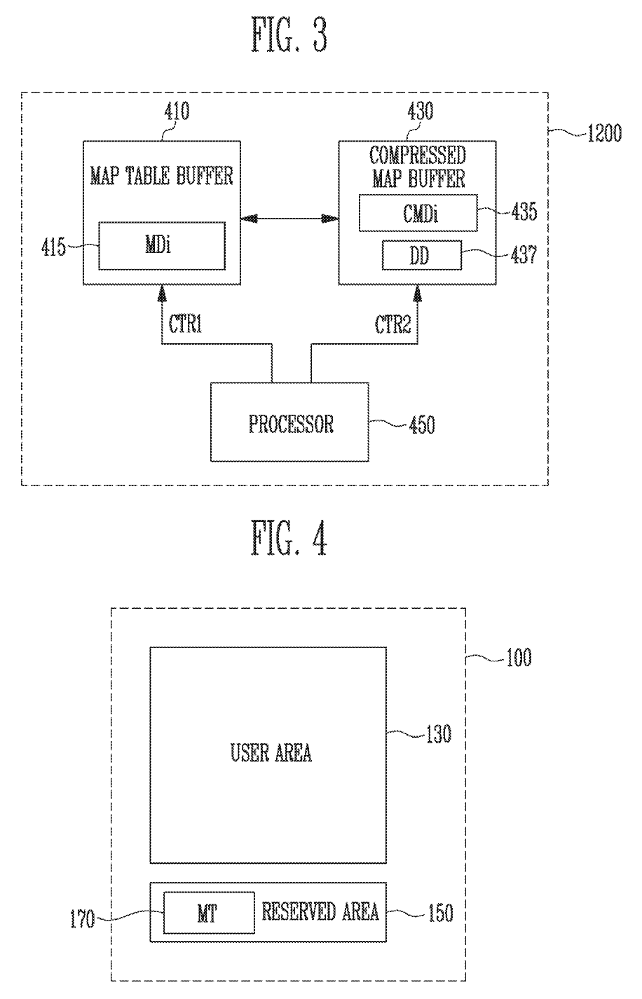

FIG. 3 is a block diagram illustrating the memory controller 1200 in accordance with an embodiment of the present disclosure.

Referring to FIG. 3, the memory controller 1200 in accordance with the embodiment of the present disclosure includes a map table buffer 410, a compressed map buffer 430, and a processor 450. Meanwhile, although not shown in FIG. 3, the memory controller 1200 may further include components to control an operation of the memory device 1100 in response to a request from the host 2000.

The map table buffer 410 stores map data MDi 415. The memory device 1100 may store a map table representing a relationship between physical and logical addresses of data stored in the memory cell array 100. The map data MDi may correspond to a part of the map table stored in the memory cell array 100. As the capacity of the memory cell array 100 increases, the total data size of the map table increases. Therefore, the memory controller 1200 may perform an operation by loading only a piece of map data MDi among plural pieces of map data MD1 to MDn included in the entire map table from the memory cell array 100 into the map table buffer 410. In an example, when a read request is received from the host 200, the memory controller 1200 receives a piece of map data MDi including a logical address corresponding to the read request from the memory device 1100 and stores the received map data MDi in the map table buffer 410. Subsequently, the memory controller 1200 generates a read command, based on the received map data MDi, and transfers the generated read command to the memory device 1100. The memory device 1100 reads corresponding data in response to the received read command and transfers the read data to the memory controller 1200. The memory controller 1200 transfers the received data to the host 2000.

According to the above-described procedure, whenever the host 2000 transfers a read request to the memory controller 1200, map data MDi is to be transferred from the memory device 1100 to the memory controller 1200. This results in a decrease in the operation speed of the memory system 1000.

The memory controller 1200 in accordance with the embodiment of the present disclosure generates compressed map data CMDi by compressing a piece of map data MDi updated in a program operation, and stores the generated compressed map data CMDi 435 in the compressed map buffer 430. Subsequently, when a read request is received from the host 2000, the memory controller 1200 determines whether the compressed map data CMDi 435 includes a logical address corresponding to the received read request with reference to the compressed map buffer 430. When the compressed map data CMDi 435 includes the logical address corresponding to the received read request, the memory controller 1200 loads a piece of map data MDi 415 including the logical address corresponding to the received read request by decompressing the compressed map data CMDi 435 into the map table buffer 410. Subsequently, the memory controller 1200 may control a read operation of the memory device 1100, based on the loaded map data MDi. More specifically, the memory controller 1200 may generate a read command and a physical address corresponding thereto, based on the loaded map data MDi, and transfer the read command and the physical address to the memory device 1100. In this procedure, a process of reading the map data MDi from the memory device 1100 is not required to be performed, and thus the operation speed of the memory system 1000 can be improved. Consequently, according to the memory controller 1200 and an operating method thereof in accordance with the embodiment of the present disclosure, the operation speed of the memory system 1000 can be improved by reducing the number where map data is read from the memory device 1100.

The compressed map buffer 430 stores compressed map data CMDi generated by compressing map data MDi as described above. The compressed map data CMDi may be generated using various compression methods. In an example, the memory controller 1200 may generate the compressed map data CMDi by compressing the map data MDi, using a run-length compression method. In another example, the memory controller 1200 may generate the compressed map data CMDi by compressing the map data MDi, using a Lempel-Ziv-Welch (LZW) compression method. In still another example, the memory controller 1200 may generate the compressed map data CMDi by compressing the map data MDi, using a variable-length compression method. In the memory controller 1200 and the operating method thereof in accordance with the embodiment of the present disclosure, the compression method of generating the compressed map data CMDi is not limited to the above examples, and the compressed map data CMDi may be generated using several other compression methods well known in the art.

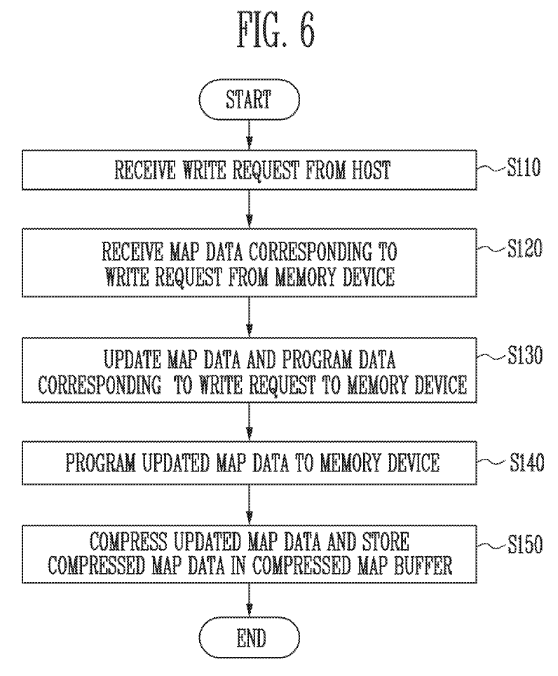

Meanwhile, the compressed map buffer 430 may store a data descriptor DD 437 in addition to the compressed map data CMDi. The data descriptor DD 437 may indicate logical addresses included in the compressed map data CMDi. The relationship of the map data MDi 415, the compressed map data CMDi 435, and the data descriptor DD 437 will be described in more detail with reference to FIG. 5B.

The map table buffer 410 and the compressed map buffer 430 may be implemented with a storage device for temporarily storing data. For example, the map table buffer 410 and the compressed map buffer 430 may be implemented with various types of storage devices such as a DRAM, an SRAM, and a register.

The processor 450 controls operations of the map table buffer 410 and the compressed map buffer 430. More specifically, the processor 450 may control an operation of the map table buffer 410 through a first control signal CTR1, and control an operation of the compressed map buffer 430 through a second control signal CTR2. The processor 450 may be implemented with a microcontroller, a microprocessor, etc. Meanwhile, the processor 450 may control the overall operations of the memory controller 1200 in addition to the map table buffer 410 and the compressed map buffer 430.

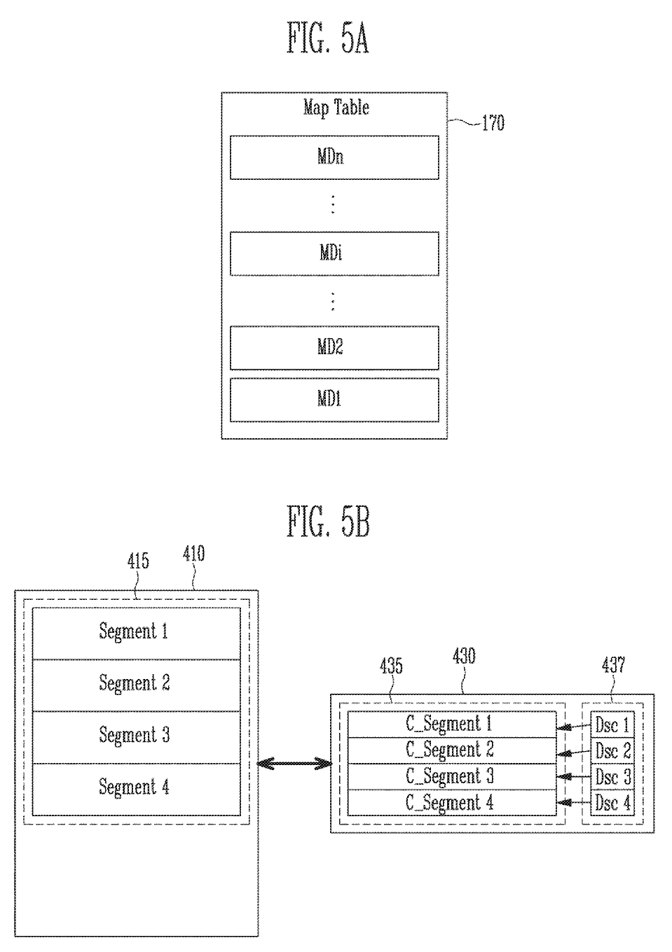

FIG. 4 is a diagram illustrating a map table stored in a memory cell array 100 of the memory device 1100.

Referring to FIG. 4, the memory cell array 100 may be divided into a user area 130 and a reserved area 150. Each of the user area 120 and the reserved area 150 may include a plurality of memory blocks. Data received from the host 2000 may be stored in the user area 130. Various data except the data received from the host 2000 may be stored in the reserved area. For example, content addressable memory (CAM) data may be stored in the reserved area 150. Meanwhile, a map table MT 170 may be stored in the reserved area 150. Data included in the map table 170 may be loaded by the memory controller 1200.

FIG. 5A is a diagram illustrating in more detail a configuration of the map table 170. FIG. 5B is a diagram illustrating a relationship of map data MDi, compressed map data CMDi, and a data descriptor DD.

Referring to FIG. 5A, the map table 170 may include plural pieces of map data MD1 to MDn. The map table 170 may represent a mapping relationship between physical and logical addresses of all data stored in the user area 130 in the memory cell array 100 of the memory device 1100. Therefore, the map data MD1 to MDn constituting a portion of the map table 170 may represent a mapping relationship between physical and logical addresses of some data among all the data stored in the user area 130. In a read operation, map data including a corresponding address mapping relationship is transferred to the memory controller 1200. Among the plural pieces of map data MD1 to MDn, a piece of map data MDi may be loaded onto the map table buffer 410.

Referring to FIG. 5B, a piece of map data 415 included in the map table buffer 410 includes a plurality of segments Segment 1 to Segment 4. Although FIG. 5B illustrates that the piece of map data 415 includes four segments Segment 1 to Segment 4, this is merely illustrative, and various numbers of segments may be included in the map data 415.

Meanwhile, the compressed map buffer 430 stores compressed map data 435. The compressed map data 435 includes a plurality of compression segments C_Segment 1 to C._Segment 4. The compression segments C_Segment 1 to C_Segment 4 may correspond to the segments Segment 1 to Segment 4 included in the map data 415, respectively. For example, a first segment Segment 1 may be compressed to constitute a first compression segment C_Segment 1, and a second segment Segment 2 may be compressed to constitute a second compression segment C_Segment 2. Meanwhile, a third segment Segment 3 may be compressed to constitute a third compression segment C_Segment 3, and a fourth segment Segment 4 may be compressed to constitute a fourth compression segment C_Segment 4. The segments may have different compression rates.

Meanwhile, the compressed map buffer 430 includes a data descriptor 437. The data descriptor 437 includes descriptors Dsc 1 to Dsc 4. The descriptors Dsc 1 to Dsc 4 may indicate logical addresses included in corresponding compression segments C_Segment 1 to C_Segment 4, respectively.

For example, a first descriptor Dsc 1 may represent that the first compression segment C_Segment 1 includes a mapping relationship of first to mth logical addresses.

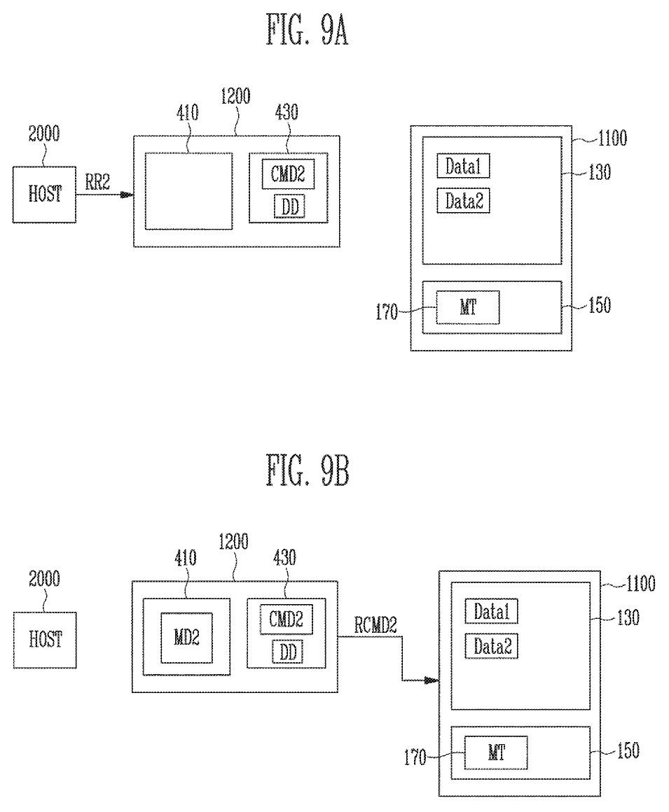

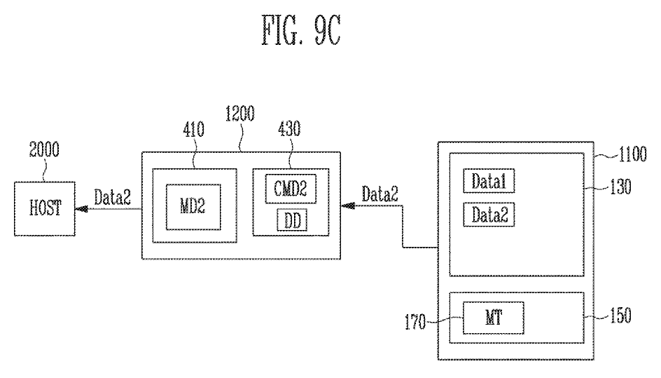

A method for performing a read operation, using the map data 415, the compressed map data 435, and the data descriptor 437, will be described in more detail with reference to FIGS. 9A to 10C.

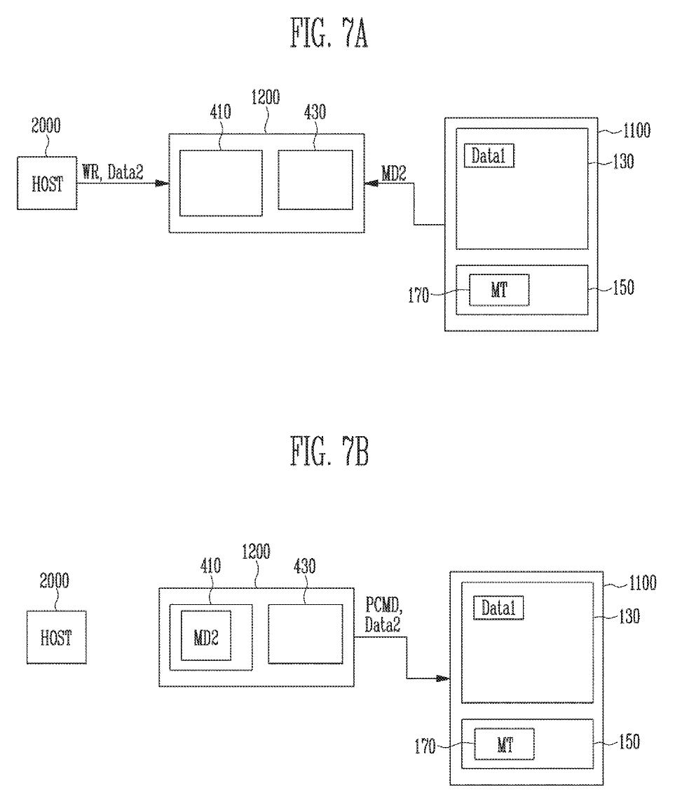

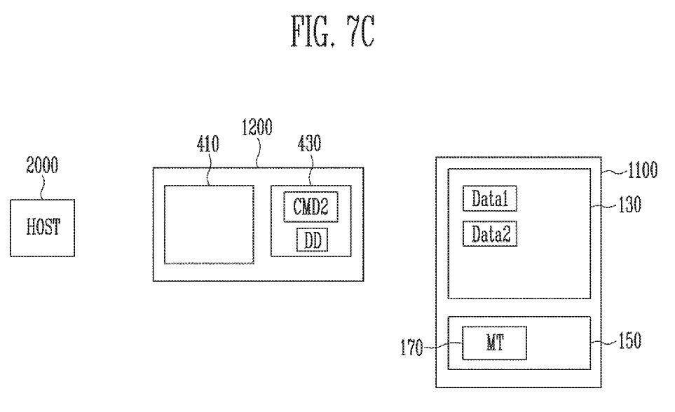

FIG. 6 is a flowchart illustrating an operating method of the memory controller in accordance with an embodiment of the present disclosure. FIGS. 7A to 7C are block diagrams illustrating the operating method shown in FIG. 6. In FIGS. 7A to 7C, only the map table buffer 410 and the compressed map buffer 430 of the memory controller 1200 are illustrated for convenience of description, and illustration of the other components is omitted. In addition, only the user area 130 and the reserved area 150 in the memory cell array 100 of the memory device 1100 are illustrated, and illustration of the other components is omitted. Hereinafter, the operating method of the memory controller in accordance with the embodiment of the present disclosure will be described with reference to FIGS. 6 and 7A to 7C together.

In step S110 of FIG. 6, the memory controller receives a write request from the host 2000. As shown in FIG. 7A, the host 2000 transfers a write request WR and second data Data2 to the memory controller 1200. The second data Data2 is a target data to be written in response to the write request WR. First data Data1 has already been stored in the user area 130 of the memory device 1100.

In step S120, the memory controller 1200 receives map data MD2 corresponding to the write request WR from the memory device 1100. As the second data Data2 is transferred, map data MD2 is transferred from the memory device 1100 to the memory controller 1200 under the control of the memory controller 1200. The map data MD2 may include a relationship between logical and physical addresses of the second data Data2. The map data MD2 may be a piece of map data among plural pieces of map data MD1 to MDn stored in the map table MT.

In step S130, the memory controller 1200 updates the map data MD2, and programs data corresponding to the write request WR to the memory device 1100. As shown in FIG. 7B, the map data MD2 is loaded into the map table buffer 410. The memory controller 1200 updates the map data MD2 by reflecting a mapping relationship of the second data Data2 corresponding to the write request WR. In addition, a program command PCMD is generated based on the map data MD2. The program command PCMD may include a physical address at which the second data Data2 is to be stored.

The program command PCMD and the second data Data2 are transferred to the memory device 1100. Subsequently, as shown in FIG. 7C, the second data Data2 is programmed in the user area 130 of the memory device 1100.

In step S140, the memory controller 1200 programs the updated map data MD2 to the memory device 1100. In step S150, the memory controller 1200 compresses the updated map data MD2 and stores the compressed map data CMD2 in the compressed map buffer. The updated map data MD2 is transferred to the memory device 1100 to be programmed in the reserved area 150. Accordingly, the map table 170 of the reserved area 150 is updated.

In addition, compressed map data CMD2 is generated by compressing the updated map data MD2. The generated compressed map data CMD2 is stored in the compressed map buffer 430. Meanwhile, a data descriptor DD may be generated together with the compressed map data CMD2 to be simultaneously stored in the compressed map buffer 430.

Subsequently, when another data write request is received from the host 2000, additional compressed map data may be stored in the compressed map buffer 430, using the operating method shown in FIG. 6.

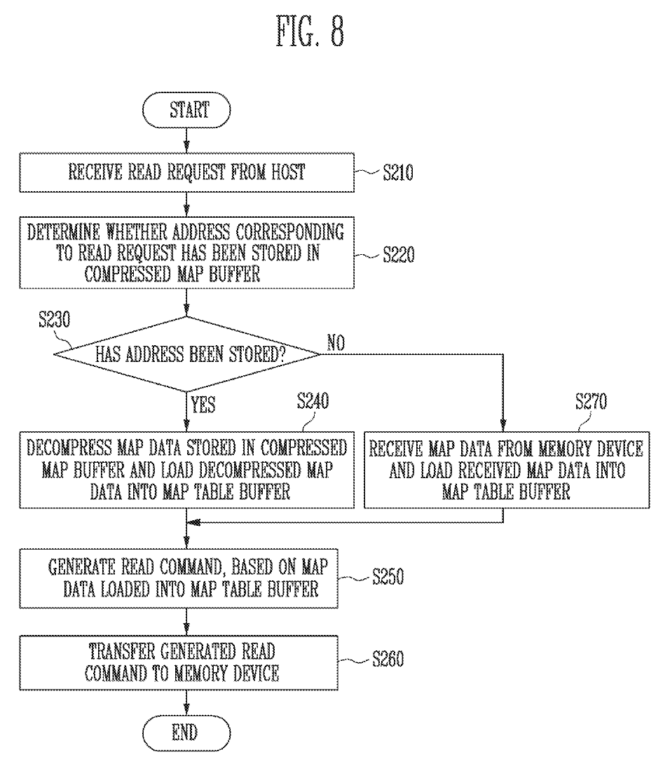

FIG. 8 is a flowchart illustrating an operating method of the memory controller 1200 in accordance with another embodiment of the present disclosure. FIGS. 9A to 9C are block diagrams illustrating a read process using compressed map data. FIGS. 10A to 10C are block diagrams illustrating a read process using map data received from the memory device.

First, the operating method of the memory controller 1200 in accordance with the embodiment of the present disclosure will be described with reference to FIGS. 8 and 9A to 9C.

In step S210, the memory controller 1200 receives a read request from host 2000. As shown in FIG. 9A, a read request RR2 is received from the host 2000. The read request RR2 is a request for reading second data Data2.

In step S220, the memory controller 1200 determines whether an address corresponding to the read request RR2 has been stored in the compressed map buffer CMD2. The memory controller 1200 may determine whether a logical address corresponding to the read request RR2 is included in compressed map data CMD2, with reference to the data descriptor DD of the compressed map buffer 430.

When the address is stored in the compressed map buffer 430 as the determination result of step S230, the memory controller 1200 decompresses the compressed map data CMD2 stored in the compressed map buffer 430 and loads the decompressed map data MD2 into the map table buffer 410 at step S240. As shown in FIG. 9B, map data MD2 is generated by decompressing the compressed map data CMD2. The generated map data MD2 is loaded into the map table buffer 410.

In step S250, the memory controller 1200 generates a read command RCMD2, based on the map data MD2 loaded in the map table buffer 410. In step S260, the memory controller 1200 transfers the generated read command RCMD2 to the memory device 1100. As shown in FIG. 9B, a read command RCMD2 generated through the map data MD2 is transferred to the memory device 1100. Subsequently, as shown in FIG. 9C, data Data2 corresponding to the read command RCMD2 is transferred to the memory controller 1200 and then transferred to the host 2000.

Hereinafter, the operating method of the memory controller 1200 in accordance with the embodiment of the present disclosure will be described with reference to FIGS. 10A to 10C. FIGS. 10A to 10C are block diagrams illustrating a process of reading data corresponding to an address that is not stored in compressed map data CMD2.

As shown in FIG. 10A, a read request RR1 is received from the host 2000 at step S210. The read request RR1 is a request for reading first data Data1. Subsequently, the memory controller 1200 determines whether an address corresponding to the read request RR1 has been stored in the compressed map buffer CMD2 at step S220. As a result obtained by referring to the data descriptor DD, the address corresponding to the read request RR1 is not stored in the compressed map buffer 430, and therefore, the operating method proceeds to step S270 obtained by performing the step S230.

In the step S270, the memory controller 1200 receives map data MD1 from the memory device 1100 and loads the received map data MD1 into the map table buffer 410. Since map data MD1 corresponding to the read request RR1 does not exist in the compressed map buffer 430, map data MD1 is transferred from the map table MT as shown in FIG. 10A.

In the step S250, as shown in FIG. 10B, a read command RCMD1 is generated based on the map data MD1 loaded into the map table buffer 410. The generated read command RCMD1 is transferred to the memory device 1100 at step S260. Subsequently, as shown in FIG. 10C, the first data Data1 corresponding to the read command RCMD1 is transferred to the host 2000 through the memory controller 1200.

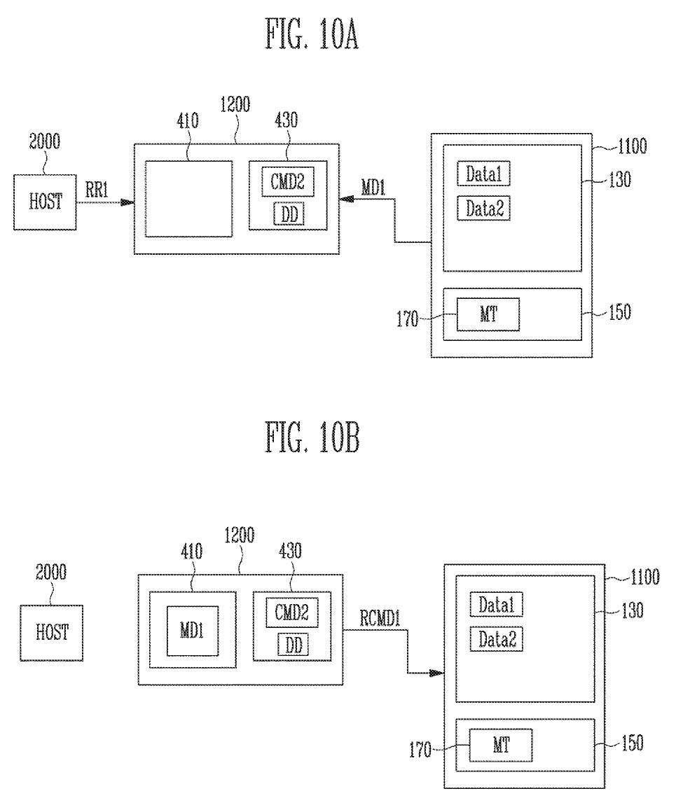

FIG. 11 is a diagram illustrating another embodiment of the memory system including the memory controller shown in FIG. 3.

Referring to FIG. 11, the memory system 3000 may be implemented as a cellular phone, a smart phone, a tablet PC, a personal digital assistant (PDA), or a wireless communication device. The memory system 3000 may include a memory device 1100 and a memory controller 1200 capable of controlling an operation of the memory device 1100. The memory controller 1200 may control a data access operation of the memory device 1100, e.g., a program operation, an erase operation, a read operation, or the like under the control of a processor 3100.

Data programmed in the memory device 1100 may be output through a display 3200 under the control of the memory controller 1200.

A radio transceiver 3300 may transmit/receive radio signals through an antenna ANT. For example, the radio transceiver 3300 may convert a radio signal received through the antenna ANT into a signal that can be processed by the processor 3100. Therefore, the processor 3100 may process a signal output from the radio transceiver 3300 and transmit the processed signal to the memory controller 1200 or the display 3200. The memory controller 1200 may transmit the signal processed by the processor 3100 to the memory device 1100. Also, the radio transceiver 3300 may convert a signal output from the processor 3100 into a radio signal, and output the converted radio signal to an external device through the antenna ANT. An input device 3400 is a device capable of inputting a control signal for controlling an operation of the processor 3100 or data to be processed by the processor 3100, and may be implemented as a pointing device such as a touch pad or a computer mount, a keypad, or a keyboard. The processor 3100 may control an operation of the display 3200 such that data output from the memory controller 1200, data output from the radio transceiver 3300, or data output from the input device 3400 can be output through the display 3200.

In some embodiments, the memory controller 1200 capable of controlling an operation of the memory device 1100 may be implemented as a part of the processor 3100, or be implemented as a chip separate from the processor 3100.

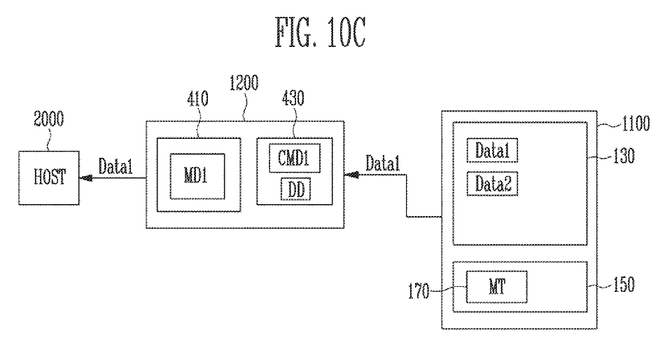

FIG. 12 is a diagram illustrating another embodiment of the memory system including the memory controller shown in FIG. 3.

Referring to FIG. 12, the memory system 4000 may be implemented as a personal computer (PC), a tablet PC, a net-book, an e-reader, a personal digital assistant (PDA), a portable multimedia player (PMP), an MP3 player, or an MP4 player.

The memory system 4000 may include a memory device 1100 and a memory controller 1200 capable of controlling a data processing operation of the memory device 1100.

A processor 4100 may output data stored in the memory device 1100 through a display 4300 according to data input through an input device 4200. For example, the input device 4200 may be implemented as a pointing device such as a touch pad or a computer mouse, a keypad, or a keyboard.

The processor 4100 may control overall operations of the memory system 40000, and control an operation of the memory controller 1200. In some embodiments, the memory controller 1200 capable of controlling an operation of the memory device 1100 may be implemented as a part of the processor 4100, or be implemented as a chip separate from the processor 4100.

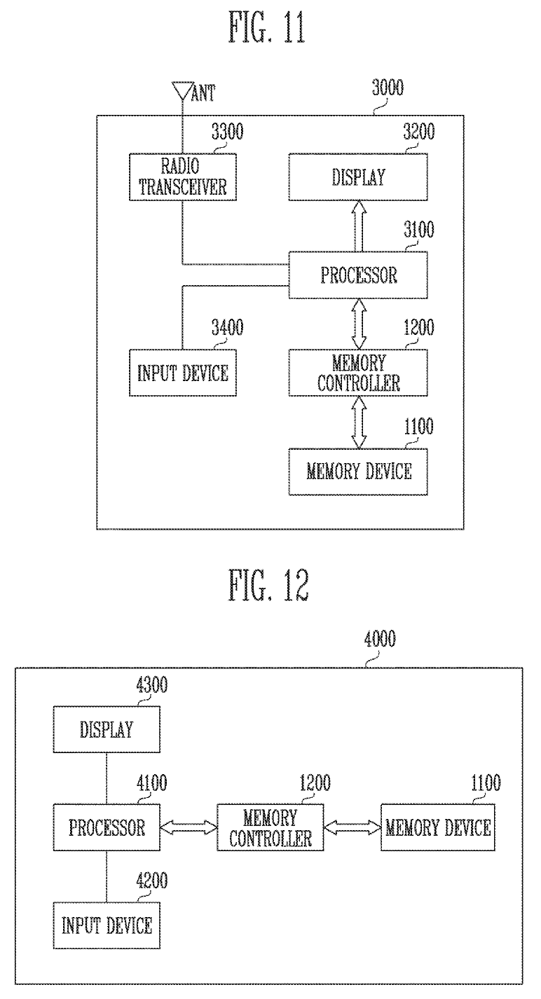

FIG. 13 is a diagram illustrating another embodiment of the memory system including the memory controller shown in FIG. 3.

Referring to FIG. 13, the memory system 5000 may be implemented as an image processing device, e.g., a digital camera, a mobile terminal having a digital camera attached thereto, a smart phone having a digital camera attached thereto, or a tablet PC having a digital camera attached thereto.

The memory system 5000 may include a memory device 1100 and a memory controller 1200 capable of controlling a data processing operation of the memory device 1100, e.g., a program operation, an erase operation, or a read operation.

An image sensor 5200 of the memory system 50000 may convert an optical image into digital signals, and the converted digital signals may be transmitted to a processor 5100 or the memory controller 1200. Under the control of the processor 5100, the converted digital signals may be output through a display 5300, or be stored in the memory device 1100 through the memory controller 1200. In addition, data stored in the memory device 1100 may be output through the display 5300 under the control of the processor 5100 or the memory controller 1200.

In some embodiments, the memory controller 1200 capable controlling of an operation of the memory device 1100 may be implemented as a part of the processor 5100, or be implemented as a chip separate from the processor 5100.

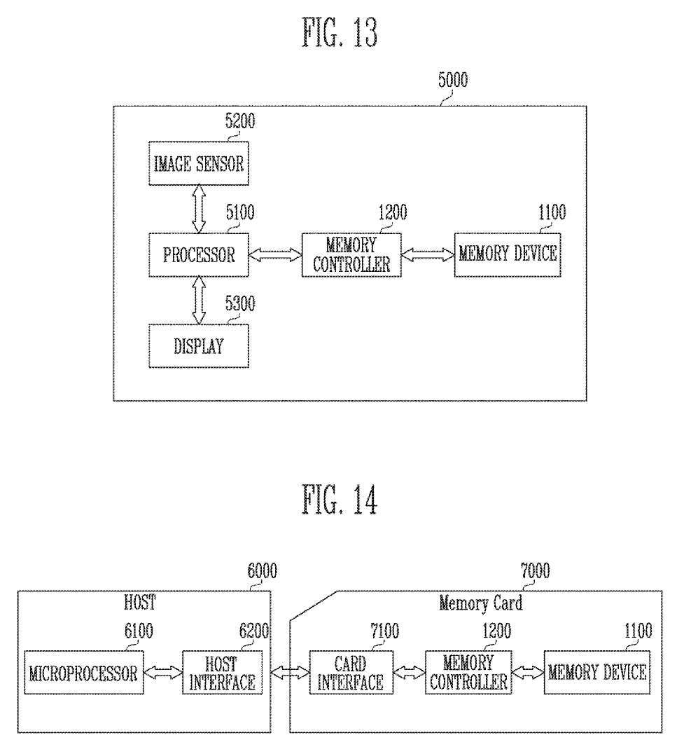

FIG. 14 is a diagram illustrating another embodiment of the memory system including the memory controller shown in FIG. 3.

Referring to FIG. 14, the memory system 7000 may be implemented as a memory card or a smart card. The memory system 7000 may include a memory device 1100, a memory controller 1200, and a card interface 7100.

The memory controller 1200 may control data exchange between the memory device 1100 and the card interface 7100. In some embodiments, the card interface 7100 may be a secure digital (SD) card interface or a multi-media card (MMC) interface, but the present disclosure is not limited thereto.

The card interface 7100 may interface data exchange between a host 6000 and the memory controller 1200 according to a protocol of the host 6000. In some embodiments, the card interface 7100 may support a universal serial bus (USB) protocol and an inter-chip (IC)-USB protocol. The card interface 7100 may mean hardware capable of supporting a protocol used by the host 6000, software embedded in the hardware, or a signal transmission scheme.

When the memory system 7000 is coupled to a host interface 6200 of the host 6000 such as a PC, a tablet PC, a digital camera, a digital audio player, a cellular phone, console video game hardware, or a digital set-top box, the host interface 6200 may perform data communication with the memory device 1100 through the card interface 7100 and the memory controller 1200 under the control of a microprocessor 6100.

In accordance with the present disclosure, there can be provided a memory controller capable of improving the operation speed of the memory system.

Further, in accordance with the present disclosure, there can be provided an operating method of a memory controller capable of improving the operation speed of the memory system.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A memory controller for controlling an operation of a memory device, the memory controller comprising:
a map table buffer configured to store map data received from the memory device;
a compressed map buffer configured to store compressed map data generated by compressing the map data; and
a processor configured to control operations of the map table buffer and the compressed map buffer.

2. The memory controller of claim 1, wherein the memory controller:
receives a write request, write data, and a write logical address from a host;
receives the map table data from a reserved area of the memory device;
controls the memory device to perform a program operation on the write data at a physical address corresponding to the write logical address, based on the map data; and
updates the map data according to the program operation.

3. The memory controller of claim 2, wherein the processor controls the map table buffer and the compressed map buffer to compress the map data updated according to the program operation of the memory device and store the compressed map data as the compressed map data in the compressed map buffer.

4. The memory controller of claim 3, wherein the memory controller controls the memory device to program the updated map data in the reserved area.

5. The memory controller of claim 3, wherein the compressed map buffer stores a descriptor of data included in the compressed map data.

6. The memory controller of claim 5, wherein the memory controller:
receives a read request and a read logical address from the host; and
determines whether a descriptor corresponding to the read logical address has been stored in the compressed map buffer.

7. The memory controller of claim 6, wherein the memory controller:
when the descriptor corresponding to the read logical address is stored in the compressed map buffer, generates the map data by decompressing the compressed map data, and loads the generated map table data into the map table buffer; and
controls the memory device to read data, based on the loaded map data.

8. The memory controller of claim 6, wherein the memory controller:
when the descriptor corresponding to the read logical address is not stored in the compressed map buffer, receives map data corresponding to the read logical address and loads the received map data into the map table buffer; and
controls the memory device to read data, based on the loaded map data.

9. A method for operating a memory controller for controlling an operation of a memory device, the method comprising:
receiving a write request from a host;
receiving map data corresponding to the write request from the memory device;
updating the map data and controlling the memory device to program data corresponding to the write request;
controlling the memory device to program the updated map data to the memory device; and
compressing and storing the updated map data.

10. The method of claim 9, wherein, in the compressing and storing of the updated map data, the updated map data is stored as compressed map data in a compressed map buffer.

11. The method of claim 10, wherein, in the compressing and storing of the updated map data, a descriptor of data included in the compressed map data is stored in the compressed map buffer.

12. A method for operating a memory controller for controlling an operation of a memory device, the method comprising:
receiving a read request from a host;
determining whether an address corresponding to the read request has been stored in a compressed map buffer; and
loading map data, based on the determination result.

13. The method of claim 12, wherein, in the loading of the map data, based on the determination result, when the address corresponding to the read request is stored in the compressed map buffer, compressed map data stored in the compressed map buffer is decompressed and then loaded as the map data.

14. The method of claim 12, wherein, in the loading of the map data, based on the determination result, when the address corresponding to the read request is not stored in the compressed map buffer, the map data is received from the memory device.

15. The method of claim 12, further comprising, after the loading of the map data, based on the determination result, generating a read command, based on the loaded map data.

16. A memory system comprising:
a memory device including a cell array storing plural pieces of map data, each representing physical and logical locations of user data stored in the cell array;
a first buffer configured to buffer one among the plural pieces of map data loaded from the cell array;
a second buffer configured to buffer a compressed piece of map data corresponding to the piece of map data buffered in the first buffer and information indicating the logical locations included in the compressed pieces; and
a processor configured to:
control, in response to a write request, the memory device to store user data into the cell array by loading the piece of map data onto the first buffer;
update the loaded piece of map data according to the storing of the user data;
control the memory device to store the updated piece of map data;
compress the updated piece of map data; and
generate the information according to the storing of the user data.

17. The memory system of claim 16, wherein the processor is further configured to:
detect, in response to a read request, a read logical address included in the compressed piece of map data by referring to the information;
decompress the compressed piece of map data into the first buffer; and
control the memory device to perform a read operation based on the decompressed piece of map data.
